(19) United States
(12) Patent Application Publication
(10) Pub. No.: US 2001/0017987 A1
(43) Pub. Date: Aug. 30, 2001

(54) Device and method for electrically connecting flexible printed wiring boards

(75) Inventor: Yasuhiko Tanaka, Saitama (JP)

Correspondence Address: YOUNG & THOMPSON, 745 SOUTH 23RD STREET 2ND FLOOR, ARLINGTON, VA, 22202

(73) Assignee: Fuji Photo Optical Co., Ltd.

(21) Appl. No.: 09/790,806

(22) Filed: Feb. 23, 2001

(30) Foreign Application Priority Data
Feb. 29, 2000 (JP) 2000-053964

(51) Int. Cl. G03B 17/00

(52) U.S. Cl. 396/542

(57) ABSTRACT

A camera has at least two flexible printed wiring boards stacked on one another. First and second securing members squeeze the two printed wiring boards. A ridge portion is formed to project from the first securing member, for pressing the two printed wiring boards to the second securing member, so as to tighten contact between the two printed wiring boards.

### BACKGROUND OF THE INVENTION

1. Field of the Invention

The present invention relates to a device and method for electrically connecting flexible printed wiring boards. More particularly, the present invention relates to a device and method for electrically connecting flexible printed wiring boards in which the printed wiring boards can be reliably kept connected even by a simple structure.

2. Description Related to the Prior Art

A camera as an electronic equipment accommodates flexible printed wiring boards. Various electric elements are incorporated in the camera of even a portable size, to operate in a state electrically connected by the printed wiring boards. Each of the printed wiring boards are obtained by forming circuit patterns on a soft insulating sheet by means of photo etching. An upper surface of the printed wiring boards are provided with a driving IC, CPU and other circuit elements connected thereto. Outer surfaces of the circuit patterns are covered by insulating covering material. The printed wiring boards are flexed if required, and accommodated in the electronic equipment compactly.

Recently the use of the printed wiring boards has been widespread in view of reduction in the size of the electronic equipment. A stack of a plurality of the printed wiring boards is used in a state electrically connected with one another. To this end, the printed wiring boards in the stack are suitably positioned and kept in contact with one another. JP-A 11-204908 discloses an example of connecting the printed wiring boards to one another. A securing rubber member and a securing metal member are used to squeeze the printed wiring boards. Resiliency of the securing rubber member operates for keeping the connection.

However, the number of the printed wiring boards in the stack may be three or more. Two or more pairs of opposed contact point patterns may be kept in contact with one another at one position by one structure. If the printed wiring boards are squeezed together between the securing rubber member and securing metal member, failure in connection is likely to occur because pressure of the securing rubber member is not applied to the printed wiring boards in a regularized manner. As the pressure of the securing rubber member is dispersed by the printed wiring boards, failure in the connection is more likely to occur in one of the printed wiring boards farther from the securing rubber member, because the pressure received by the farther board is smaller. It is also conceivable that two or more positions may be determined in the printed wiring boards for keeping the contact by applying pressure. However, there occur a problem of a larger space of mounting the printed wiring boards. This is inconsistent to reducing the size of the electronic equipment.

### SUMMARY OF THE INVENTION

In view of the foregoing problems, an object of the present invention is to provide a device and method for electrically connecting flexible printed wiring boards in which the printed wiring boards can be reliably kept connected even by a simple structure.

In order to achieve the above and other objects and advantages of this invention, a connecting device is provided for connecting at least first and second flexible printed wiring boards with one another, the first printed wiring board having at least one first contact point, the second printed wiring board having at least one second contact point. In the connecting device, a first member, being elastic, receives the first printed wiring board, the first and second printed wiring boards being so stacked as to set the first and second contact points in contact with each other. A second member, being rigid, receives the second printed wiring board. A projection is formed with the second member, for pushing the second printed wiring board so as to keep pressure high between the first and second contact points. A retention member pushes the second member toward the first member, to squeeze the first and second printed wiring boards.

In a preferred embodiment, the first member is formed from rubber.

The first member is placed on a wall of an equipment body.

The retention member is a screw member secured to the equipment body.

The projection extends in one first direction.

Furthermore, at least one positioning pin is disposed to project from the equipment body. Holes are formed in the first and second printed wiring boards, and fitted on the positioning pin.

Furthermore, holes are formed in the first and second printed wiring boards and the first and second members, for receiving insertion of the retention member. The first and second contact points are disposed close to a periphery of the holes.

In other words, an electric equipment comprises at least first and second flexible printed wiring boards stacked on one another. The first printed wiring board further includes a first contact point pattern. The second printed wiring board includes a second contact point pattern, opposed to the first contact point pattern, and kept in contact with the first contact point pattern by pressure of the projection portion to the first or second printed wiring board.

The at least first and second printed wiring boards are at least first, second and third printed wiring boards stacked on one another in sequence. The second printed wiring board further includes a third contact point pattern positioned in reverse to the second contact point pattern. The third printed wiring board includes a fourth contact point pattern, opposed to the third contact point pattern, and kept in contact with the third contact point pattern by pressure of the projection portion to the first printed wiring board.

The at least one projection portion is a ridge extending in one direction.

In another preferred embodiment, the at least one projection portion is a ridge extending in a ring shape.

The electric equipment is a camera.

According to another aspect of the invention, a connecting method is provided for connecting at least first and second flexible printed wiring boards with one another. In the connecting method, there is provided a step of stacking the first printed wiring board on the second printed wiring board so as to set at least one first contact point of the first printed wiring board in contact with at least one second contact point of the second printed wiring board. The first and second printed wiring boards are squeezed between first and second members, the first member being elastic, the second member being rigid, there being a projection formed with the second member, for contacting the first or second printed wiring board so as to keep pressure high between the first and second contact points.

### BRIEF DESCRIPTION OF THE DRAWINGS

The above objects and advantages of the present invention will become more apparent from the following detailed description when read in connection with the accompanying drawings, in which:

FIG. 1 is a perspective illustrating a camera having flexible printed wiring boards;

FIG. 2 is a perspective illustrating a rear of the camera;

FIG. 3 is a perspective illustrating a state of the camera in which a photo film cassette is ready to be inserted;

FIG. 4 is a horizontal section illustrating the printed wiring boards and relevant structure in the camera;

FIG. 5 is an exploded perspective illustrating the printed wiring boards and elements for securing those;

FIG. 6 is a cross section illustrating the printed wiring boards secured in the camera; and

FIG. 7 is an exploded perspective illustrating another preferred embodiment in which securing rings secure the printed wiring boards.

### DETAILED DESCRIPTION OF THE PREFERRED EMBODIMENT(S) OF THE PRESENT INVENTION

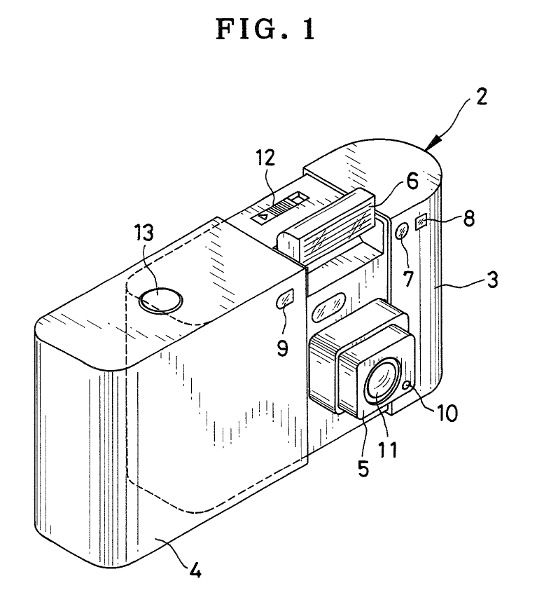

In FIG. 1, a camera 2 is illustrated in a state of taking an exposure. The camera 2 includes a camera body 3 and a sliding cover 4. The camera body 3 has a box shape and has various mechanisms for taking an exposure. The sliding cover 4 is fitted on the outside of the camera body 3 in a slidable manner. The sliding cover 4 is formed from lightweight material with high strength, examples of which are plastic material, aluminum, titanium and the like. When the camera 2 is not used, nearly the entirety of the camera body 3 is contained in the sliding cover 4 in a compact manner. Portability of the camera 2 is raised as outer protruding or retreating portions of the camera body 3 are covered. To take an exposure, the camera body 3 is drawn from the sliding cover 4, which is used as a grip.

The camera 2 has a lens barrel 5, a flash emitter 6, a viewfinder objective window 7, a rangefinding projecting window 8 and rangefinding receiving window 9, which appear in the front face of the camera 2 when the camera 2 is ready to take a photograph. The lens barrel 5 includes a photometric receiving window 10 and a taking lens 11. The lens barrel 5, when a power source for the camera 2 is turned off, is contained in the camera body 3, and when the power source for the camera 2 is turned on, is advanced from the camera body 3. The flash emitter 6 is pivotally movable between ineffective and effective positions, and when in the ineffective position, contained in the camera body 3, and when in the effective position, popped up on the top of the camera body 3. A spring is secured to the flash emitter 6. Upon drawing of the camera body 3 from the sliding cover 4, the spring causes the flash emitter 6 to rotate to the effective position. The power source of the camera 2 is turned on in response to the rotation of the flash emitter 6 to the effective position.

An upper face of the camera 2 has an unlocking button 12 and a shutter release button 13. A cover locking mechanism locks the sliding cover 4 when the sliding cover 4 is in a photographing position. When the sliding cover 4 is slid from the photographing position to a cassette loading position, the unlocking button 12 is operated to unlock the cover locking mechanism. The shutter release button 13 is depressed halfway so as to cause a rangefinding device and a photometric device to operate for rangefinding and photometry. When the shutter release button 13 is depressed fully, the shutter mechanism is released. When the sliding cover 4 is in the photographing position, the shutter release button 13 is located at an upper face of the shutter switch of the camera body 3. When the shutter release button 13 is depressed, the shutter switch is turned on.

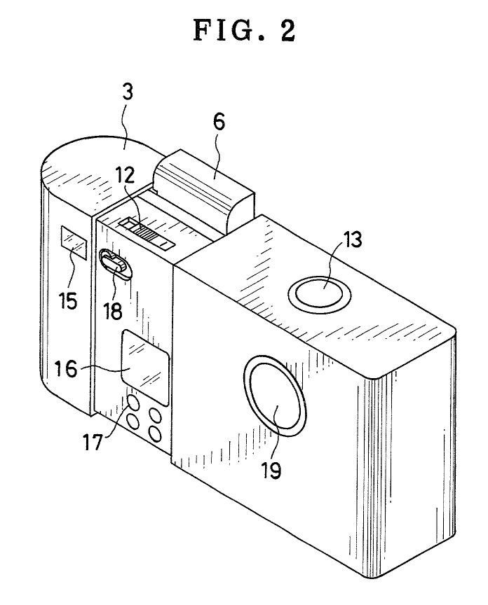

In FIG. 2, the rear of the camera body 3 has a viewfinder eyepiece window 15, a liquid crystal display (LCD) panel 16, operation buttons 17, a size selector button 18 and a zoom button 19. Among the operation buttons 17, there is a rewinding button which is depressed for the purpose of rewinding the photo film even before all frames are exposed. When the sliding cover 4 is slid to the photographing position, the zoom button 19 becomes confronted with a zoom switch (not shown) disposed in the camera body 3 and having a semi-circular shape.

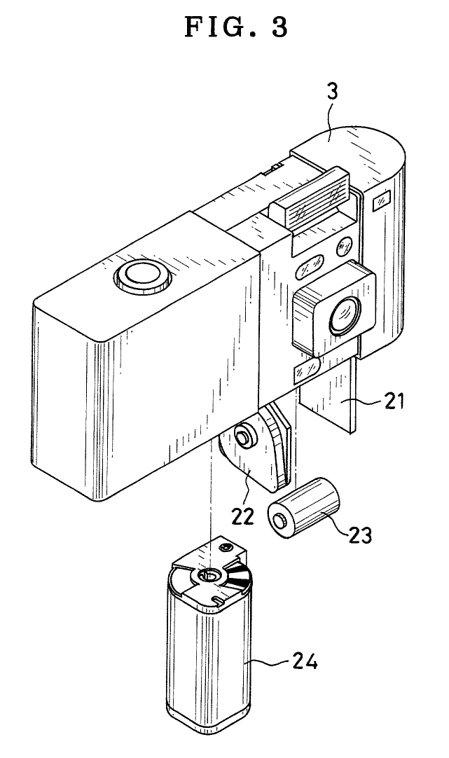

In FIG. 3, a battery chamber lid 21 and a cassette chamber lid 22 are disposed in a lower face of the camera body 3. The battery chamber lid 21 and the cassette chamber lid 22 are openable only while the sliding cover 4 is set in the cassette loading position. A battery 23 and a photo film cassette 24 can be loaded and unloaded by setting the sliding cover 4 in the cassette loading position.

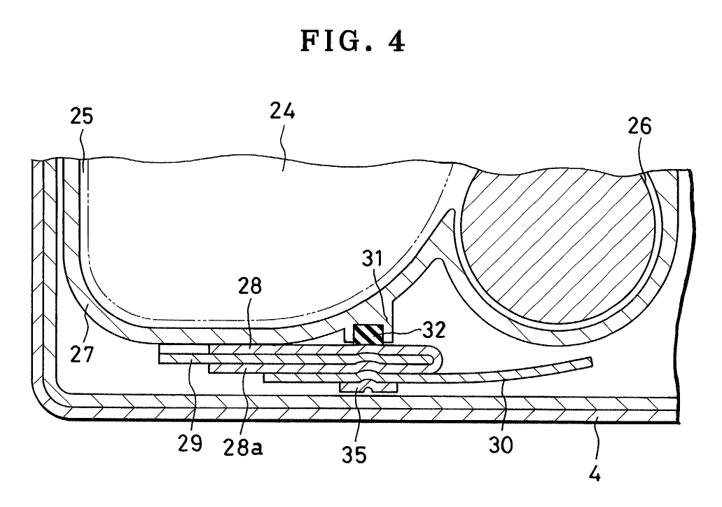

In FIG. 4, inner portions of the camera body 3 are depicted. A camera body part 27 in the camera body 3 is provided with a cassette holder chamber 25 and a capacitor holder chamber 26, and also has electric devices for taking an exposure. Plural flexible printed wiring boards 28, 29 and 30 are secured to the camera body part 27 for driving and controlling the electric devices. Each of the printed wiring boards 28-30 are obtained by forming circuit patterns on a soft insulating sheet by means of photo etching. Outer surfaces of the circuit patterns are covered by insulating covering material. An upper surface of the printed wiring boards 28-30 are provided with a driving IC, CPU and other circuit elements connected by soldering. A contact point pattern is formed in at least one surface of each of the printed wiring boards 28-30 for connection with one another, and includes plural contact points.

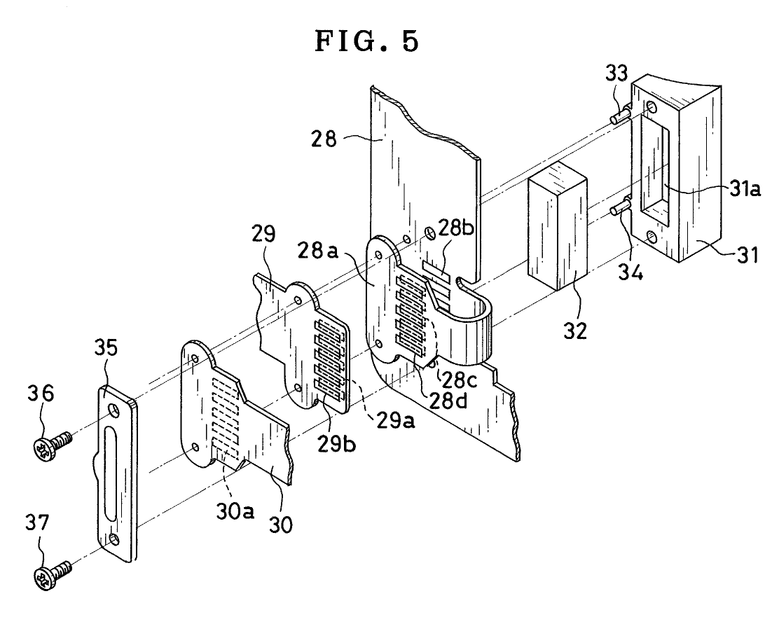

In FIGS. 4 and 5, a board support portion 31 is formed with a front wall of the cassette holder chamber 25 in the camera body part 27, and adapted to disposing the printed wiring boards 28-30. A recess 31a is formed in the board support portion 31. A first member 32 of rubber has a shape of a rectangular parallelepiped and is inserted in the recess 31a. Pins 33 and 34 are formed with the board support portion 31 to protrude, and adapted to positioning of the printed wiring boards 28-30 in a stationary manner. A second member 35 or plate is secured to the board support portion 31 by fastening with retention screws 36 and 37 as retention members.

The printed wiring board 28 secured to the board support portion 31 is included in circuits for control of the camera. A tongue 28a protrudes from the printed wiring board 28, and is bent back and receives insertion of the pins 33 and 34 for positioning. A front surface of a base part of the printed wiring board 28 has a contact point pattern 28b. Two surfaces of the tongue 28a have respectively contact point patterns 28c and 28d. The printed wiring board 29 is connected to a detector device, which detects a state of the use of the photo film cassette 24 inserted in the camera. The printed wiring board 30 is connected to an electronic flash device. Surfaces of the printed wiring board 29 have respectively contact point patterns 29a and 29b. A rear surface of the printed wiring board 30 has a contact point pattern 30a. Each of the contact point patterns 28b-28d, 29a, 29b and 30a is an array of plural contact points shaped in a rectangular quadrilateral.

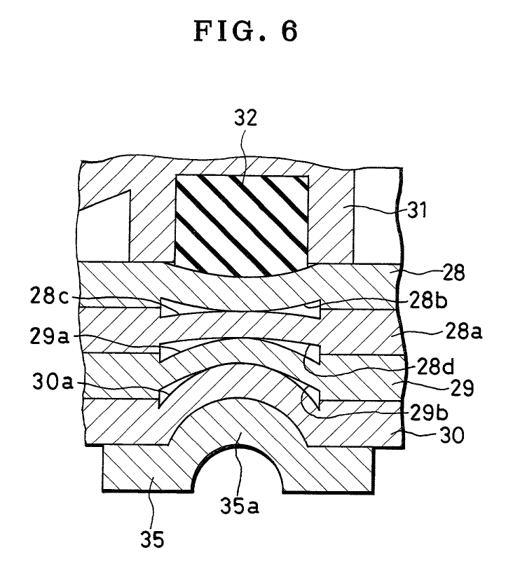

The first member 32 is inserted in the recess 31a of the board support portion 31, and located behind the printed wiring boards 28-30. The first member 32 applies pressure to each of the contact points in a regularized manner. In FIG. 6, a ridge portion 35a as projection portion is formed to project from the second member 35 in a position facing the first member 32, and keeps the contact point patterns in contact with each other. Also, lengths of the first member 32 and the ridge portion 35a are greater than a length of the range of the contact point pattern. Consequently, the contact point patterns of the printed wiring boards 28-30 and the tongue 28a can be reliably contacted by one another.

The operation of connecting the printed wiring boards according to the embodiment is described next. In the camera body part 27, the first member 32 is inserted into the recess 31a in the board support portion 31. Then the printed wiring boards 28-30 and the tongue 28a are placed on the camera body part 27 and positioned by means of the pins 33 and 34. As the pins 33 and 34 operate to determine positions of the printed wiring boards 28-30 relative to the board support portion 31, all the contact point patterns of the printed wiring boards 28-30 can come in contact suitably with one another.

After positioning the printed wiring boards 28-30 with the tongue 28a, the second member 35 is fitted. The ridge portion 35a of the second member 35 is directed toward the first member 32, and retained to the board support portion 31 fixedly by means of the retention screws 36 and 37. In FIG. 6, the ridge portion 35a of the second member 35 pushes, or biases, the contact point patterns in the rearward direction that is upward in the drawing. The first member 32 is deformed resiliently. The first member 32 exerts force of reaction toward the printed wiring board 28 in the direction downward in the drawing. Squeezing of the first member 32 and the second member 35 presses the printed wiring boards 28-30 and the tongue 28a against one another, to connect the contact point patterns firmly with each other.

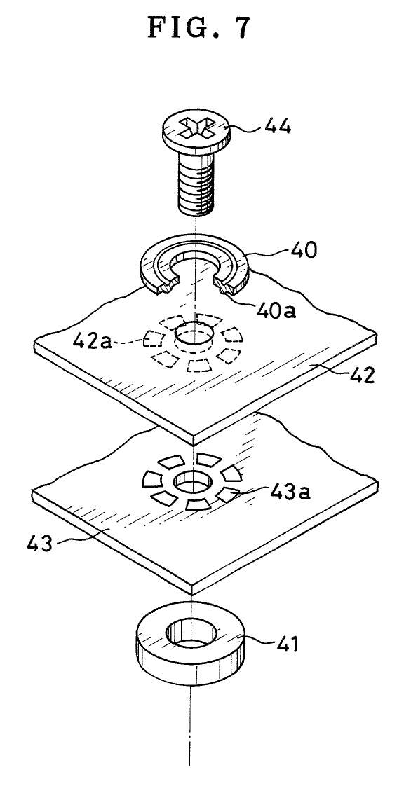

In the above embodiment, each of the contact point patterns 28b-28d, 29a, 29b and 30a is an array of plural contact points. Another preferred embodiment is depicted in FIG. 7, in which each contact point pattern includes contact points arranged circularly. A first ring 41 of rubber and a second ring 40 have a circular shape. The second ring 40 is provided with a ridge portion 40a as projection portion. Plural flexible printed wiring boards 42 and 43 are squeezed between the first and second rings 40 and 41. A retention screw 44 as retention member fastens those to the board support portion 31 or a suitable portion of the camera body part 27. Thus, contact point patterns 42a and 43a of the printed wiring boards 42 and 43 can be kept in contact with each other reliably by the first and second rings 40 and 41. It is to be noted that a contact point pattern according to the present invention may have contact points arranged in a shape other than the array or ring. The shape of the securing members may have a suitably modified shape according to the shape in which the contact points are arranged in the contact point pattern.

In the above embodiments, the board support portion 31 is located in the front wall of the cassette holder chamber 25 for positioning of the printed wiring boards 28-30. Furthermore, the securing of the printed wiring boards 28-30 according to the invention may be used in combination with a board support portion located in any suitable manner. In the above embodiments, the electric equipment in which the printed wiring boards 28-30 are connected is the camera. Furthermore, the connection of the printed wiring boards 28-30 may be used in any type of electric equipment or electronic equipment.

In the above embodiment, the first member 32, 41 is formed from rubber. Alternatively, the first member 32, 41 may be formed from material having sufficient resiliency, such as polyurethane foam. In the above embodiment, the second member 35, 40 is formed from metal. Alternatively, the second member 35, 40 may be formed from resin or other material having sufficient rigidity.

In the above embodiments, the ridge portion 35a, 40a has a single continuous shape. However, the ridge portion 35a may be a combination of two or more projections arranged in line. The ridge portion 40a may be a combination of plural projections arranged on a circle.

In the above embodiments, the second member 35, 40 is fastened by the retention screws 36 and 37 or the retention screw 44. Alternatively, the second member 35, 40 may be fastened to a board support portion by means of rubber bands, clips or other suitable structure for retention.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A connecting device for connecting at least first and second flexible printed wiring boards with one another, said first printed wiring board having at least one first contact point, said second printed wiring board having at least one second contact point, said connecting device comprising:
a first member, being elastic, for receiving said first printed wiring board, said first and second printed wiring boards being so stacked as to set said first and second contact points in contact with each other;
a second member, being rigid, for receiving said second printed wiring board;
a projection, formed with said second member, for pushing said second printed wiring board so as to keep pressure high between said first and second contact points; and
a retention member for pushing said second member toward said first member, to squeeze said first and second printed wiring boards.

2. A connecting device as defined in claim 1, wherein said first member is formed from rubber, and said second member is formed from metal.

3. A connecting device as defined in claim 2, wherein said first member is inserted in a recess in an equipment body.

4. A connecting device as defined in claim 3, wherein said retention member is a screw member secured to said equipment body.

5. A connecting device as defined in claim 4, wherein said first member has a box shape and is longer in a first direction, said second member is a plate and is longer in said first direction, and said projection extends in said first direction.

6. A connecting device as defined in claim 5, further comprising:
at least one positioning pin, disposed to project from said equipment body; and
holes, formed in said first and second printed wiring boards, and fitted on said positioning pin.

7. A connecting device as defined in claim 4, further comprising holes, formed in said first and second printed wiring boards and said first and second members, for receiving insertion of said retention member;
wherein said first and second contact points are disposed close to a periphery of said holes.

8. A connecting method of connecting at least first and second flexible printed wiring boards with one another, comprising steps of:
stacking said first printed wiring board on said second printed wiring board so as to set at least one first contact point of said first printed wiring board in contact with at least one second contact point of said second printed wiring board;
squeezing said first and second printed wiring boards between first and second members, said first member being elastic, said second member being rigid, there being a projection formed with said second member, for contacting said first or second printed wiring board so as to keep pressure high between said first and second contact points.

9. A connecting method as defined in claim 8, wherein said first member is formed from rubber, and said second member is formed from metal.
